(19) United States
(12) Patent Application Publication
(10) Pub. No.: US 2007/0148550 A1
(43) Pub. Date: Jun. 28, 2007

(54) Non-aqueous electrolyte secondary battery

(76) Inventors: Kazuhiro Hasegawa, Kobe-city (JP); Yasufumi Takahashi, Kobe-city (JP); Shingo Tode, Kobe-city (JP); Akira Kinoshita, Itano-gun (JP); Tatsuyuki Kuwahara, Itano-gun (JP); Hiroyuki Fujimoto, Kobe-city (JP)

Correspondence Address: KUBOVCIK & KUBOVCIK, SUITE 710, 900 17TH STREET NW, WASHINGTON, DC, 20006, US

(21) Appl. No.: 11/645,805

(22) Filed: Dec. 27, 2006

(30) Foreign Application Priority Data
Dec. 28, 2005 (JP) 2005-379230
Nov. 24, 2006 (JP) 2006-317053

(51) Int. Cl. H01M 4/66; H01M 4/58

(52) U.S. Cl. 429/245; 429/231.95

(57) ABSTRACT

Low-temperature charge-discharge performance is improved in a non-aqueous electrolyte secondary battery that employs flake graphite as a negative electrode active material. A non-aqueous electrolyte secondary battery includes a positive electrode containing a positive electrode active material capable of intercalating and deintercalating lithium ions, a negative electrode containing a negative electrode active material capable of intercalating and deintercalating lithium ions, and a non-aqueous electrolyte. The negative electrode includes a mixture layer (1) containing, as the negative electrode active material, a graphite material having flake-shaped primary particles, a current collector (3) made of Cu or a Cu alloy, and an intermediate layer (2) disposed between the mixture layer (1) and the current collector (3) and composed of a material that intercalates and deintercalates lithium ions at a nobler potential than the graphite material.

### BACKGROUND OF THE INVENTION

1. Field of the Invention

The present invention relates to non-aqueous electrolyte secondary batteries, and more particularly to a non-aqueous electrolyte secondary battery having improved operating performance at low temperatures.

2. Description of Related Art

A high energy density battery that has drawn attention in recent years is a non-aqueous electrolyte secondary battery that employs a negative electrode active material made of a carbon material, a lithium-containing oxide, metallic lithium, or an alloy capable of absorbing and desorbing lithium ions, and a positive electrode active material made of a lithium-containing transition metal composite oxide represented by the chemical formula LiMO₂ (where M is a transition metal).

Examples of the metals and alloys that are commonly used as the negative electrode active material include Sn, Si, Sn alloys, and Si alloys. Examples of the lithium-containing oxide include Li₄Ti₅O₁₂. A representative example of the carbon material is graphite. A non-aqueous electrolyte secondary battery that employs a carbon material as the negative electrode active material and uses LiCoO₂ or LiCO_{1/3}Mn_{1/3}Ni_{1/3}O₂ as the positive electrode active material has already been in commercial use.

One application of the foregoing battery includes use in portable electronic devices, such as notebook computers and mobile telephones. Since the portable electronic devices are often used outdoors, the battery that is the power source of the devices is required to operate properly in a wide temperature range, e.g., from a low temperature of 0° C. or below to a high temperature of 40° C. or above.

In recent years, as the number of functions of the portable electronic devices has increased, demand for a battery with a higher capacity has been growing. Accordingly, much research has been conducted on improvements to the positive electrode active material and the negative electrode active material. Among the carbon materials that are used for the negative electrode active material, graphite material has been particularly intensively investigated because it is considered advantageous for use in power sources of portable electronic devices owing to its advantages such as high capacity per unit weight, high reversibility in lithium intercalation and deintercalation reactions, flat discharge profile at low potentials, and a high true density. In particular, with graphite having flake-shaped primary particles (hereinafter referred to as “flake graphite” or “graphite flakes”) it has become possible to show charge-discharge characteristics that are close to the theoretical capacity. The graphite flakes can be oriented parallel to the electrode plate when the electrode plate is compressed to increase the density. Therefore, the flake graphite is advantageous in terms of the filling density of the active material. For this reason, the flake graphite allows the negative electrode to achieve a higher mixture density and accordingly have a higher capacity per volume.

The battery that uses flake graphite as a negative electrode active material and has an electrode in which the mixture density is enhanced by compressing the electrode plate when fabricating the electrode has the problem of capacity degradation that occurs during the operation at low temperatures. This is believed to be due to the decrease in the amount of electrolyte that can be retained in the electrode because primary particles of the flake graphite are oriented when the electrode plate is compressed and also the active material is filled at a high density, and the ion diffusion velocity in the non-aqueous electrolyte reduces in a low-temperature environment.

In order to solve the foregoing problem, Japanese Published Unexamined Patent Application No. 8-287952 proposes the use of a mixture of flake graphite and spheroidal graphite. However, the electrode shows a poorer active material filling density than the case in which the flake graphite is used alone, and achieving a high capacity has been difficult.

In addition, during low temperature charging, the ion diffusion velocity in the non-aqueous electrolyte lowers, and therefore, when lithium ions are intercalated into graphite, the supply of lithium ions tends to be insufficient in the portion of the negative electrode active material layer that is near the current collector. As a result, side reactions other than the lithium intercalation into the graphite take place, resulting in a poor charge-discharge efficiency and degradation in the battery performance.

Various attempts have been made to minimize such degradation in battery performance during low-temperature operations. For example, Japanese Published Unexamined Patent Application No. 2001-283858 discloses that addition of dialkylsulfosuccinate ester to the negative electrode enhances the affinity between graphite and the electrolyte solution, to obtain a non-aqueous electrolyte secondary battery having good low-temperature performance. Nevertheless, as the filling density of the negative electrode active material is increased in order to meet the demand of higher battery capacity, the amount of the electrolyte retained in the negative electrode active material decreases, reducing the number of lithium-ion diffusion paths. Thus, the enhancement of the affinity between graphite and the electrolyte solution as attempted in JP 2001-283858A alone has been unable to sufficiently improve the low-temperature charge-discharge performance of a battery.

Japanese Published Unexamined Patent Application Nos. 2001-283834, 2003-223898, 2005-293960, and 10-92414 as well as Japanese Patent Nos. 3520921 and 3535454 disclose a negative electrode construction in which a layer of a material capable of absorbing and desorbing lithium ions is provided on a current collector made of Cu or the like, and a carbon material layer is provided thereon. However, these publications do not specifically disclose the use of flake graphite as the carbon material. Moreover, these publications do not mention the issue of preventing the degradation in battery capacity during low-temperature operations.

### BRIEF SUMMARY OF THE INVENTION

Accordingly, it is an object of the present invention to provide a non-aqueous electrolyte secondary battery employing flake graphite as a negative electrode active material that achieves improved low-temperature charge-discharge performance.

In order to accomplish the foregoing and other objects, the present invention provides a non-aqueous electrolyte secondary battery comprising: a positive electrode containing a positive electrode active material capable of intercalating and deintercalating lithium ions; a negative electrode containing a negative electrode active material capable of intercalating and deintercalating lithium ions, and comprising a mixture layer, a current collector made of Cu or a Cu alloy, and an intermediate layer disposed between the mixture layer and the current collector, the mixture layer containing as the negative electrode active material a graphite material having flake-shaped primary particles and a binder, the content of the flake-shaped graphite particles in the mixture layer being at least 80 weight %, and the intermediate layer comprising a material that absorbs and desorbs lithium ions at a nobler potential than the graphite material; and a non-aqueous electrolyte.

The present invention allows a non-aqueous electrolyte secondary battery that uses flake graphite as a negative electrode active material to achieve excellent low-temperature charge-discharge performance.

### BRIEF DESCRIPTION OF THE DRAWINGS

FIG. 1 is a schematic cross-sectional view for illustrating the structure of the negative electrode of a non-aqueous electrolyte secondary battery according to the present invention;

FIG. 2 is a perspective view for illustrating the shape of a primary particle of the graphite flakes used as the negative electrode active material in the present invention;

FIG. 3 is a schematic view illustrating how lithium ions are intercalated into the negative electrode active material during charge in the case of using graphite flakes as the negative electrode active material;

FIG. 4 is a schematic view illustrating how lithium ions are intercalated into the negative electrode active material during charge in the case of using spheroidal graphite or carbon fibers;

FIG. 5 is a plan view illustrating a non-aqueous electrolyte secondary battery fabricated as an example according to the present invention;

FIG. 6 is a graph illustrating the relationship between negative electrode mixture density and low-temperature charge-discharge efficiency; and

FIG. 7 is a graph illustrating the relationship between number of charge-discharge cycles and capacity retention ratio.

### DETAILED DESCRIPTION OF THE INVENTION

In accordance with the present invention, a non-aqueous electrolyte secondary battery comprises a positive electrode, a negative electrode, and a non-aqueous electrolyte. The positive electrode contains a positive electrode active material capable of intercalating and deintercalating lithium ions. The negative electrode contains a negative electrode active material capable of intercalating and deintercalating lithium ions. The negative electrode comprises a mixture layer, a current collector, and an intermediate layer. The mixture layer contains, as the negative electrode active material, a graphite material having flake-shaped primary particles. The current collector is made of Cu or a Cu alloy. The intermediate layer is disposed between the mixture layer and the current collector, and is made of a material that absorbs and desorbs lithium ions at a nobler potential than the graphite material.

In the present invention, the negative electrode is provided with the intermediate layer, which is made of a material that absorbs and desorbs lithium ions at a nobler (electrode) potential than flake graphite, disposed on the current collector made of Cu or a Cu alloy, and with the mixture layer, which contains flake graphite as a negative electrode active material, disposed on the intermediate layer. Since the intermediate layer is, in accordance with the present invention, arranged in the vicinity of the current collector, the absorption reaction of lithium ions takes place in the intermediate layer at first during charge, causing the lithium ions to be consumed in the vicinity of the current collector. This produces a concentration gradient of lithium ions in the non-aqueous electrolyte that is retained in the negative electrode, making it possible to accelerate the diffusion velocity of the lithium ions from the vicinity of the negative electrode surface toward the vicinity of the current collector. Thereby, charge-discharge characteristics at low temperatures can be improved.

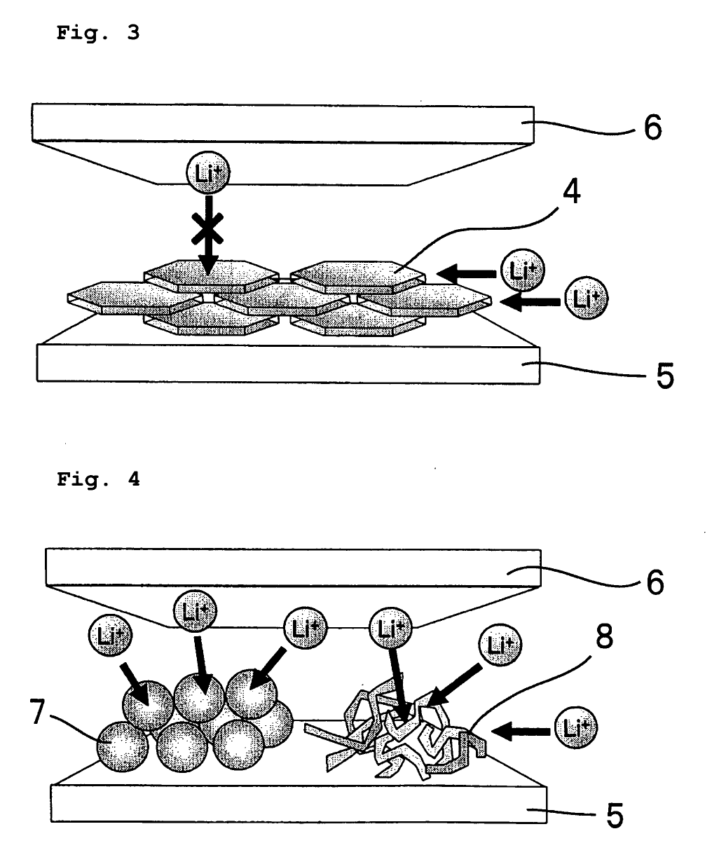

FIG. 3 is a schematic view for illustrating the cause of degradation in low-temperature charge-discharge performance in the case of using flake graphite as the negative electrode active material. As illustrated in FIG. 3, flake graphite 4 is used for a negative electrode 5 as a negative electrode active material. Flake graphite 4 has an advantage of high capacity per unit weight and high initial charge-discharge efficiency. Moreover, flake graphite 4 can be highly orientated because it is in a flaked shape, and it can achieve a high density when the electrode plate is compressed by a pressure-rolling process or the like in fabricating an electrode.

During charge, lithium ions supplied from a positive electrode 6 need to be intercalated into the graphite. However, as illustrated in FIG. 3, the edge surfaces of the flakes of the flake graphite 4, into which lithium ions can be inserted, are oriented perpendicularly to the positive electrode 6, and the flake graphite 4 tends to show poor lithium ion receptability. This problem becomes more serious when the orientation capability of the flake graphite 4 is increased in order to achieve a higher filling density. When the lithium ion receptability becomes poor in this way, the low-temperature charge-discharge performance of the battery degrades.

FIG. 4 is a schematic view illustrating a negative electrode that uses spheroidal graphite 7 made from mesophase pitch or carbon fiber 8 in place of the flake graphite 4. Unlike the flake graphite, neither the spheroidal graphite 7 nor the carbon fiber 8 shows orientation capability. Therefore, they show a small anisotropy at the time of the lithium ion insertion and good lithium ion receptability, and do not result in such degradation in the charge-discharge characteristics at low temperatures as mentioned above. On the other hand, the spheroidal graphite or carbon fibers cannot achieve a high density such as achieved with the use of flake graphite because much space remains even after the electrode plate is compressed.

According to the present invention, even when the flake graphite 4 is filled at a high density as illustrated in FIG. 3, the degradation in the lithium ion receptability can be minimized, and consequently the low-temperature charge-discharge performance can be improved.

FIG. 2 is a perspective view for illustrating the shape of a primary particle of the flake graphite in the present invention. The flake graphite 4 generally has a thickness along the c-axis of 3 μm or less, and preferably from 0.1 μm to 3 μm. The average values of the lengths along the a-axis and the b-axis are generally three times or greater than the thickness along the c-axis.

The shape of such a flake can be observed by, for example, a scanning electron microscope.

In the present invention, the mixture layer contains the flake graphite and a binder. As the binder, any binder known for use in a negative electrode of a secondary battery can be used. Other active materials known for use in a negative electrode of a secondary battery can also be contained in the mixture layer. It is preferable that the mixture layer have a mixture density D of 0.9≦D≦2.0 g/cm³, more preferably 1.2≦D≦1.8 g/cm³. The mixture density D is a density in the mixture layer, and more specifically, it is the total density of the flake graphite serving as the negative electrode active material, a binder, and other addition agents. If the mixture density D is too low, the capacity per unit volume of the electrode reduces so that the battery may not achieve a high capacity, although the electrolyte is sufficiently filled in the mixture layer and the charge-discharge operations are possible even at low temperatures. If the mixture density D is too high, the porosity of the mixture layer may reduce excessively, so the amount of the electrolyte that can be retained in the electrode reduces, degrading the charge-discharge characteristics considerably.

In the present invention, it is preferable that the intermediate layer have a film thickness d within the range of 0.01 μm≦d≦10 μm, and more preferably within the range of 0.01 μm≦d≦5 μm.

If the film thickness d is too small, the effect of improving the low-temperature charge-discharge performance achieved by the present invention may not be sufficiently obtained. On the other hand, if the film thickness d is too thick, pulverization of the active material due to the expansion and shrinkage in volume of the intermediate layer may become evident during charge-discharge cycling, considerably degrading cycle performance.

The thickness of the mixture layer is greater than the thickness of the intermediate layer. Although it is believed that the effect of the present invention will be obtained if the mixture layer is thinner than the intermediate layer, a graphite layer thinner than 5 μm is not practical.

In the present invention, the material for forming the intermediate layer may be any kind of material as long as the material is capable of absorbing and desorbing lithium ions at a nobler potential than graphite, which is the negative electrode active material. Examples include metals that can absorb lithium ions, such as Sn and Si, alloys and oxides thereof, and lithium-containing transition metal oxides, such as Li₄Ti₅O₁₂.

Particularly preferable examples include materials that have a reaction potential for lithium absorption/desorption of 1 V or less, a high volume energy density, and are suitable for achieving a high capacity, such as Sn, Si, Sn alloys, and Si alloys.

In the present invention, the intermediate layer is not limited to having a single-layer structure, but may have a layered structure in which plural layers with various compositions are stacked. The intermediate layer may be subjected to a heat processing as necessary. The intermediate layer need not be crystalline, but may be amorphous.

The intermediate layer may be formed on the current collector by sintering, quenching, plating, sputtering, pressure-rolling, a sol-gel process, CVD, evaporation, or the like. Electroplating, sputtering, and CVD are particularly preferable to form the intermediate layer on the current collector.

The current collector in the present invention is made of Cu or a Cu alloy. Examples of the Cu alloy include CuSn, AgCu, ZrCu, CrCu, TiCu, BeCu, and FeCu.

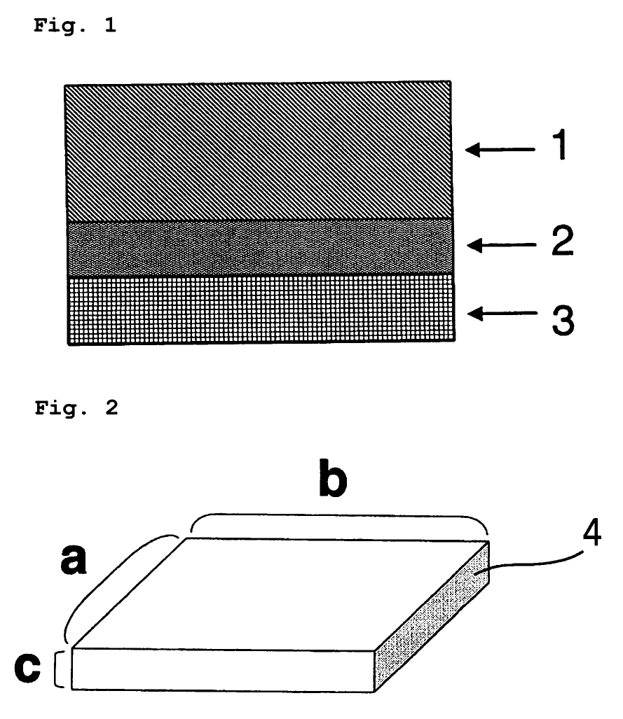

FIG. 1 is a schematic cross-sectional view for illustrating the structure of the negative electrode of the non-aqueous electrolyte secondary battery according to the present invention. As illustrated in FIG. 1, in the negative electrode of the present invention, an intermediate layer 2 made of the above-described material is formed on a current collector 3 made of Cu or a Cu alloy, and a mixture layer 1 containing flake graphite as a negative electrode active material is disposed on the intermediate layer 2.

Examples of the positive electrode active material in the present invention include: lithium-containing transition metal oxides such as lithium-cobalt composite oxide (e.g., LiCoO₂), lithium-nickel composite oxide (e.g., LiNiO₂), lithium-manganese composite oxide (e.g., LiMn₂O₄ and LiMnO₂), lithium-nickel-cobalt composite oxide (e.g., LiNi₁₋ₓCoₓO₂), lithium-manganese-cobalt composite oxide (e.g., LiMn₁₋ₓCoₓO₂), lithium-nickel-cobalt-manganese composite oxide (e.g., LiNiₓCo_{y}Mn_{z}O₂ where x+y+z=1), and lithium-nickel-cobalt-aluminum composite oxide (e.g., LiNiₓCo_{y}Al_{z}O₂ where x+y+z=1); and metal oxides such as manganese dioxide (e.g., MnO₂) and vanadium oxide (e.g., V₂O₅), as well as other oxides and sulfides.

More preferable examples of the positive electrode active material include lithium-cobalt composite oxide (LiCoO₂), lithium-nickel composite oxide (LiNiO₂), lithium-manganese composite oxide (LiMn₂O₄), lithium-nickel-cobalt composite oxide (LiNi₁₋ₓCoₓO₂), lithium-manganese-cobalt composite oxide (LiMn₁₋ₓCo_{z}O₂), lithium-nickel-cobalt-manganese composite oxide (e.g., LiNiₓCo_{y}Mn_{z}O₂ where x+y+z=1), and lithium-nickel-cobalt-aluminum composite oxide (e.g., LiNiₓCo_{y}Al_{z}O₂ where x+y+z=1), which have a high reaction potential with lithium ions and are advantageous in the energy density when made into a battery.

The positive electrode current collector may be made of any material without particular limitation, as long as the material is an electrically conductive material. Examples include aluminum, stainless steel, and titanium.

Examples of the usable conductive agent include, but are not limited to, acetylene black, graphite, and carbon black. Examples of the binder agent include, but are not limited to, polyvinylidene fluoride, polytetrafluoroethylene, EPDM, SBR, NBR, and fluorocarbon rubber.

Examples of the solute in the non-aqueous electrolyte usable for the non-aqueous electrolyte secondary battery of the present invention include, but are not particularly limited to, LiPF₆, LiBF₄, LiCF₃SO₃, LiN(CF₃SO₂)₂, LiN(C₂F₅SO₂)₂, LiN(CF₃SO₂) (C₄F₉SO₂), LiC(CF₃SO₂)₃, LiC(C₂F₅SO₂)₃, LiClO₄, Li₂B₁₀Cl₁₀, Li₂B₁₂Cl₂, and mixtures thereof.

The solvent of the non-aqueous electrolyte used in the non-aqueous electrolyte secondary battery of the present invention may be any solvent or mixture of solvents that can be used for lithium secondary batteries. A cyclic carbonate or a chain carbonate is preferable as the solvent. Examples of the cyclic carbonate include ethylene carbonate, propylene carbonate, butylene carbonate, and vinylene carbonate. Among them, ethylene carbonate is particularly preferable. Examples of the chain carbonate include dimethyl carbonate, methyl ethyl carbonate, and diethyl carbonate. Moreover, a mixed solvent of two or more solvents is also preferable as the solvent. Particularly preferable is a mixed solvent containing a cyclic carbonate and a chain carbonate. It is preferable that the proportion of the cyclic carbonate, which is less readily impregnated into a negative electrode with a high filling density, be 35 volume % or less. The proportion of cyclic carbonate is more preferably within the range of from 10 volume % to 35 volume %.

Furthermore, it is preferable that a portion of or all of the cyclic carbonate be a cyclic carbonate containing at least one fluorine atom. When using the just-mentioned solvent in the non-aqueous electrolyte solvent, a portion of the solvent decomposes on the negative electrode during charge and discharge, forming a surface film thereon, and consequently stable charge-discharge cycling becomes possible. Examples of the cyclic carbonate containing at least one fluorine atom include fluoroethylene carbonate, 4,4-difluoro-1,3-dioxolan-2-one, 4,5-difluoro-1,3-dioxolane-2-one, 4-fluoro-5-methyl-1,3-dioxolane-2-one, 4-(fluoromethyl)-1,3-dioxolane-2-one, 4-(trifluoromethyl)-1,3-dioxolane-2-one, 4-fluoro-5-(fluoromethyl)-1,3-dioxolane-2-one, 4-fluoro-5-(trifluoromethyl)-1,3-dioxolane-2-one, 4-fluoro-1,3-dioxole-2-one, 4,5-difluoro-1,3-dioxole-2-one, 4-fluoro-5-methyl-1,3-dioxole-2-one, 4-(fluoromethyl)-1,3-dioxole-2-one, 4-fluoro-5-(fluoromethyl)-1,3-dioxole-2-one, 4-(1-fluorovinyl)-1,3dioxolane-2-one, 4-(2-fluorovinyl)-1,3-dioxolane-2-one, and 4-fluoro-5-vinyl-1,3-dioxolane-2-one. Particularly preferable are fluoroethylene carbonate, 4,4-difluoro-1,3-dioxolan-2-one, 4,5-difluoro-1,3-dioxolane-2-one, 4-(fluoromethyl)-1,3-dioxolane-2-one, and 4-(trifluoromethyl)-1,3-dioxolane-2-one, from the viewpoints of solubility, stability, and manufacturability.

Furthermore, use of a mixed solvent of the above-listed cyclic carbonate(s) and an ether-based solvent such as 1,2-dimethoxyethane or 1,2-diethoxyethane is also preferable.

In addition, examples of the electrolyte in the present invention include gelled polymer electrolytes in which an electrolyte solution is impregnated into a polymer electrolyte such as polyethylene oxide or polyacrylonitrile, and inorganic solid electrolytes such as LiI and Li₃N.

### EXAMPLES

Hereinbelow, the present invention is described in further detail based on examples thereof. It should be construed, however, that the present invention is not limited to the following examples but various changes and modifications are possible without departing from the scope of the invention.

### Example 1

Preparation of Positive Electrode

Li₂CO₃ and CO₃O₄ were mixed with an Ishikawa-type automated mortar so that the mole ratio of Li:Co became 1:1. Thereafter, the mixture was sintered in an air atmosphere at 850° C. for 20 hours and thereafter pulverized, whereby a lithium-containing transition metal composite oxide was obtained. Then, carbon as a conductive agent, polyvinylidene fluoride as a binder agent, and N-methyl-2-pyrrolidone as a dispersion medium were added to the positive electrode active material obtained in the foregoing manner so that the weight ratio of the active material, the conductive agent, and the binder agent became 90:5:5, and thereafter, the resultant mixture was kneaded to prepare a positive electrode slurry. The resultant slurry was applied onto an aluminum foil current collector and then dried. Thereafter, the resultant material was pressure-rolled with pressure rollers, and a current collector tab was attached thereto. Thus, a positive electrode was prepared.

Preparation of Negative Electrode Intermediate Layer

A Sn thin film having a thickness of 1 μm was formed onto a 10 μm-thick electrolytic copper foil serving as a current collector by an electroplating technique using a plating bath of copper(II) sulfate solution. The film was thereafter dried to thus form an intermediate layer.

Preparation of Negative Electrode

Artificial graphite (thickness: about 0.5 μm, width: 2 μm or greater, as determined by SEM) having flake-shaped primary particles serving as the negative electrode active material and styrene-butadiene rubber as a binder agent were added to an aqueous solution of carboxymethylcellulose, which is a thickening agent, so that the weight ratio of the active material and the binder agent and the thickening agent became 97.5:1.0:1.5, and thereafter the resultant mixture was kneaded to prepare a negative electrode slurry. The slurry thus prepared was applied onto the current collector on which the intermediate layer was formed in the foregoing manner and then dried. Thereafter, the resultant material was pressure-rolled using pressure rollers so that the density of the negative electrode mixture became 0.96 g/cm³, and then a current collector tab was attached thereto, to thus prepare a negative electrode.

Preparation of Electrolyte Solution

Lithium hexafluorophosphate (LiPF₆) was dissolved in a mixed solvent of 3:7 volume ratio of ethylene carbonate (EC) and ethyl methyl carbonate (EMC) at a concentration 1 mole/liter, to thus prepare an electrolyte solution.

Preparation of Battery

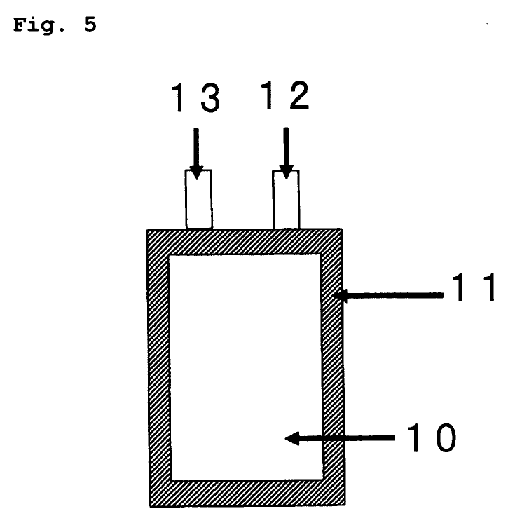

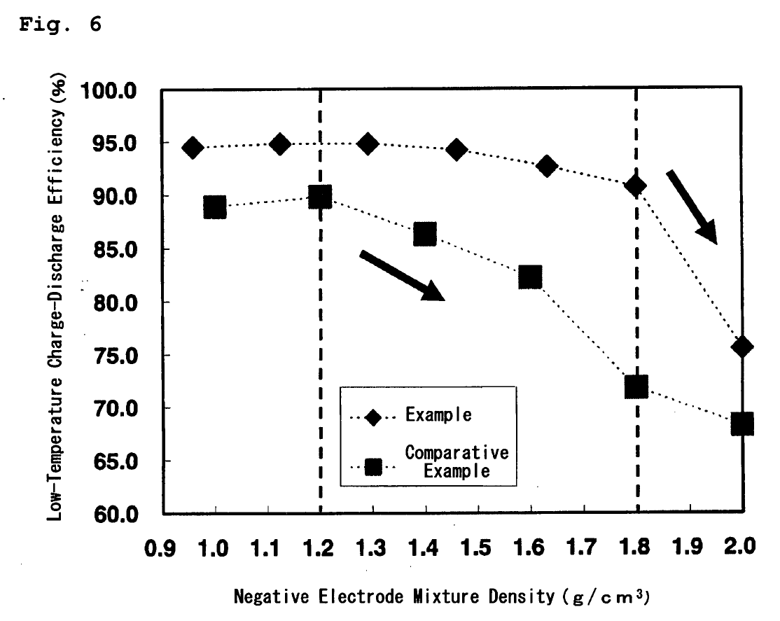

The positive electrode and the negative electrode prepared in the above-described manner were wound together so that they oppose each other across a separator interposed therebetween, to prepare a wound assembly. The wound assembly and the electrolyte solution were then sealed into an aluminum laminate as illustrated in FIG. 5, in a glove box under an Ar (argon) atmosphere, whereby a non-aqueous electrolyte secondary battery A1 in a battery standard size of 3.6 mm thickness×3.5 cm width×6.2 cm length was obtained. The non-aqueous electrolyte secondary battery thus fabricated had such a structure as illustrated in FIG. 5, in which the peripheral edges of the aluminum laminate battery case 10 were thermally welded to form a welded part 11, and a positive electrode tab 12 and a negative electrode tab 13 were extended outside. The charge capacity ratio of the opposing portions of the positive electrode and the negative electrode was designed to be 1.10 when the battery was charged at 4.2 V.

Evaluation of Low-Temperature Charge-Discharge Performance

The non-aqueous electrolyte secondary battery thus fabricated was charged with a constant current of 650 mA at a constant temperature of −5° C. until the battery voltage reached 4.2 V, then further charged with a constant voltage of 4.2 V until the current value reached 32 mA, and thereafter discharged with a constant current of 650 mA at a constant temperature of 25° C. until the battery voltage reached 2.75 V, to measure the low-temperature charge-discharge efficiency (%) of the battery and evaluate the low-temperature charge-discharge performance.

### Example 2

A non-aqueous electrolyte secondary battery A2 was fabricated in the same manner as described in Example 1, except that the density of the negative electrode mixture was set at 1.12 g/cm³ when preparing the negative electrode, and the low-temperature charge-discharge profile of the battery was evaluated.

### Example 3

A non-aqueous electrolyte secondary battery A3 was fabricated in the same manner as described in Example 1, except that the density of the negative electrode mixture was set at 1.29 g/cm³ when preparing the negative electrode, and the low-temperature charge-discharge profile of the battery was evaluated.

### Example 4

A non-aqueous electrolyte secondary battery A4 was fabricated in the same manner as described in Example 1, except that the density of the negative electrode mixture was set at 1.46 g/cm³ when preparing the negative electrode, and the low-temperature charge-discharge profile of the battery was evaluated.

### Example 5

A non-aqueous electrolyte secondary battery A5 was fabricated in the same manner as described in Example 1, except that the density of the negative electrode mixture was set at 1.63 g/cm³ when preparing the negative electrode, and the low-temperature charge-discharge profile of the battery was evaluated.

### Example 6

A non-aqueous electrolyte secondary battery A6 was fabricated in the same manner as described in Example 1, except that the density of the negative electrode mixture was set at 1.80 g/cm³ when preparing the negative electrode, and the low-temperature charge-discharge profile of the battery was evaluated.

### Example 7

A non-aqueous electrolyte secondary battery A7 was fabricated in the same manner as described in Example 1, except that the density of the negative electrode mixture was set at 2.00 g/cm³ when preparing the negative electrode, and the low-temperature charge-discharge profile of the battery was evaluated.

### Comparative Example 1

A non-aqueous electrolyte secondary battery X1 was fabricated in the same manner as described in Example 1, except that no negative electrode intermediate layer was formed and that the density of the negative electrode mixture was set at 1.00 g/cm³ when preparing the negative electrode, and the low-temperature charge-discharge profile of the battery was evaluated.

### Comparative Example 2

A non-aqueous electrolyte secondary battery X2 was fabricated in the same manner as described in Example 1, except that no negative electrode intermediate layer was formed and that the density of the negative electrode mixture was set at 1.20 g/cm³ when preparing the negative electrode, and the low-temperature charge-discharge profile of the battery was evaluated.

### Comparative Example 3

A non-aqueous electrolyte secondary battery X3 was fabricated in the same manner as described in Example 1, except that no negative electrode intermediate layer was formed and that the density of the negative electrode mixture was set at 1.40 g/cm³ when preparing the negative electrode, and the low-temperature charge-discharge profile of the battery was evaluated.

### Comparative Example 4

A non-aqueous electrolyte secondary battery X4 was fabricated in the same manner as described in Example 1, except that no negative electrode intermediate layer was formed and that the density of the negative electrode mixture was set at 1.60 g/cm³ when preparing the negative electrode, and the low-temperature charge-discharge profile of the battery was evaluated.

### Comparative Example 5

A non-aqueous electrolyte secondary battery X5 was fabricated in the same manner as described in Example 1, except that no negative electrode intermediate layer was formed and that the density of the negative electrode mixture was set at 1.80 g/cm³ when preparing the negative electrode, and the low-temperature charge-discharge profile of the battery was evaluated.

### Comparative Example 6

A non-aqueous electrolyte secondary battery X6 was fabricated in the same manner as described in Example 1, except that no negative electrode intermediate layer was formed and that the density of the negative electrode mixture was set at 2.00 g/cm³ when preparing the negative electrode, and the low-temperature charge-discharge profile of the battery was evaluated.

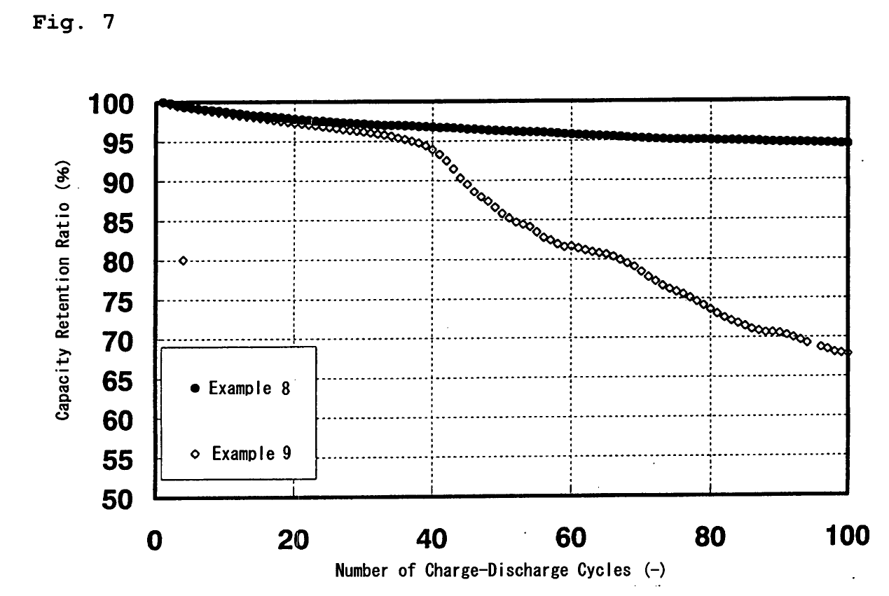

The low-temperature charge-discharge profiles of the non-aqueous electrolyte secondary batteries A1 to A7, fabricated in the manners described in Examples 1 to 7, as well as those of the non-aqueous electrolyte secondary batteries X1 to X6, fabricated in the manners described in Comparative Examples 1 to 6, are shown in Table 1 and FIG. 6.

The low-temperature charge-discharge efficiency values shown in Table 1 and FIG. 6 were obtained from the following equation.
Low-temperature charge-discharge efficiency (%)=(Discharge capacity at 25° C.)/(Charge capacity at −5° C.)×100

TABLE 1

| | | | Low-temperature |
|---|---|---|---|
| | | Negative electrode | charge-discharge |
| | | mixture density | efficiency |
| | Battery | (g/cm³) | (%) |
| Example 1 | A1 | 0.96 | 94.5 |
| Example 2 | A2 | 1.12 | 94.8 |
| Example 3 | A3 | 1.29 | 94.8 |
| Example 4 | A4 | 1.46 | 94.2 |
| Example 5 | A5 | 1.63 | 92.6 |
| Example 6 | A6 | 1.80 | 90.7 |
| Example 7 | A7 | 2.00 | 75.5 |
| Comparative | X1 | 1.00 | 88.9 |
| Example 1 | | | |
| Comparative | X2 | 1.20 | 89.8 |
| Example 2 | | | |
| Comparative | X3 | 1.40 | 86.3 |
| Example 3 | | | |
| Comparative | X4 | 1.60 | 82.2 |
| Example 4 | | | |
| Comparative | X5 | 1.80 | 71.8 |
| Example 5 | | | |
| Comparative | X6 | 2.00 | 68.2 |
| Example 6 | | | |

As clearly seen from FIG. 6 and Table 1, the batteries of the Examples in accordance with the present invention exhibit superior low-temperature charge-discharge efficiencies to the Comparative Examples. It is also demonstrated that the batteries of the Examples in which the negative electrode mixture density is in the range of from 1.2 g/cm³ to 1.8 g/cm³ exhibit particularly higher charge-discharge efficiencies than the Comparative Examples.

Evaluation of Charge-Discharge Cycle Performance

### Example 8

A non-aqueous electrolyte secondary battery B1 was fabricated in the same manner as described in the foregoing Example 5, except that a mixed solvent of 28:6:66 volume ratio of ethylene carbonate (EC), fluoroethylene carbonate (FEC), and ethyl methyl carbonate (EMC) was used as the solvent of the electrolyte solution. The non-aqueous electrolyte secondary battery B1 thus fabricated was charged with a constant current of 800 mA to a voltage of 4.2 V, then further charged with a constant voltage of 4.2 V to a current of 40 mA, and thereafter discharged with a constant current of 800 mA to a voltage of 2.75 V, to measure the initial charge-discharge capacity (800 mA) of the battery. Thereafter, the charge-discharge cycle in the just-descried charge-discharge conditions was repeated 100 times. The charge-discharge cycle performance of the battery was evaluated by determining the capacity retention ratio at each cycle, which was obtained by dividing the discharge capacity at each cycle by the initial discharge capacity.

### Example 9

A non-aqueous electrolyte secondary battery Y1 was fabricated in the same manner as described in Example 5, and the charge-discharge cycle profile of the battery was evaluated.

Table 2 and FIG. 7 show the charge-discharge cycle characteristics of the non-aqueous electrolyte secondary battery B1, fabricated in the manner described in Example 8, and the non-aqueous electrolyte secondary battery Y1, fabricated in the manner described in Example 9.

TABLE 2

| | | | Capacity |
|---|---|---|---|
| | | Electrolyte | retention ratio |
| | Battery | solution (Solvent) | at 100th cycle |
| Example 8 | B1 | EC:FEC:EMC = 28:6:66 | 94.5 |
| Example 9 | Y1 | EC:EMC = 30:70 | 68.0 |

As clearly seen from FIG. 7 and Table 2, favorable charge-discharge cycle performance is exhibited when FEC is included in the solvent.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

This application claims priority of Japanese Patent Application Nos. 2005-379230 filed Dec. 28, 2005, and 2006-317053 filed Nov. 24, 2006, which are incorporated herein by reference.

What is claimed is:

1. A non-aqueous electrolyte secondary battery comprising:
a positive electrode containing a positive electrode active material capable of intercalating and deintercalating lithium ions;
a negative electrode containing a negative electrode active material capable of intercalating and deintercalating lithium ions, and comprising a mixture layer, a current collector made of Cu or a Cu alloy, and an intermediate layer disposed between the mixture layer and the current collector, the mixture layer containing as the negative electrode active material a graphite material having flake-shaped primary particles, and the intermediate layer comprising a material that absorbs and desorbs lithium ions at a nobler potential than the graphite material; and
a non-aqueous electrolyte.

2. The non-aqueous electrolyte secondary battery according to claim 1, wherein the mixture layer has a density D of from 0.9 g/cm³ to 2.0 g/cm³.

3. The non-aqueous electrolyte secondary battery according to claim 1, wherein the mixture layer has a density D of from 1.2 g/cm³ to 1.8 g/cm³.

4. The non-aqueous electrolyte secondary battery according to claim 2, wherein the intermediate layer has a film thickness d of from 0.01 μm to 5 μm.

5. The non-aqueous electrolyte secondary battery according to claim 1, wherein the intermediate layer has a film thickness d of from 0.01 μm to 5 μm and the mixture layer has a density D of from 1.2 g/cm³ to 1.8 g/cm³.

6. The non-aqueous electrolyte secondary battery according to claim 4, wherein the intermediate layer has a reaction potential for absorbing and desorbing lithium ions of 1 V or less.

7. The non-aqueous electrolyte secondary battery according to claim 5, wherein the intermediate layer has a reaction potential for absorbing and desorbing lithium ions of 1 V or less.

8. The non-aqueous electrolyte secondary battery according to claim 6, wherein the intermediate layer is made of at least one material selected from the group consisting of Sn, Si, a Sn alloy, and a Si alloy.

9. The non-aqueous electrolyte secondary battery according to claim 8, wherein the intermediate layer is formed on the current collector by electroplating, sputtering, or CVD.

10. The non-aqueous electrolyte secondary battery according to claim 9, wherein the non-aqueous electrolyte contains a mixed solvent containing a cyclic carbonate and a chain carbonate, and the volume of the cyclic carbonate in the mixed solvent is 35 volume % or less.

11. The non-aqueous electrolyte secondary battery according to claim 10, wherein a portion of or all of the cyclic carbonate comprises a cyclic carbonate containing at least one fluorine atom.

12. The non-aqueous electrolyte secondary battery according to claim 11, wherein the cyclic carbonate containing at least one fluorine atom is fluoroethylene carbonate.

13. The non-aqueous electrolyte secondary battery according to claim 2, wherein the intermediate layer has a reaction potential for absorbing and desorbing lithium ions of 1 V or less.

14. The non-aqueous electrolyte secondary battery according to claim 3, wherein the intermediate layer has a reaction potential for absorbing and desorbing lithium ions of 1 V or less.

15. The non-aqueous electrolyte secondary battery according to claim 13, wherein the intermediate layer is made of at least one material selected from the group consisting of Sn, Si, a Sn alloy, and a Si alloy.

16. The non-aqueous electrolyte secondary battery according to claim 15, wherein the intermediate layer is formed on the current collector by electroplating, sputtering, or CVD.

17. The non-aqueous electrolyte secondary battery according to claim 16, wherein the non-aqueous electrolyte contains a mixed solvent containing a cyclic carbonate and a chain carbonate, and the volume of the cyclic carbonate in the mixed solvent is 35 volume % or less.

18. The non-aqueous electrolyte secondary battery according to claim 17, wherein a portion of or all of the cyclic carbonate comprises a cyclic carbonate containing at least one fluorine atom.

19. The non-aqueous electrolyte secondary battery according to claim 18, wherein the cyclic carbonate containing at least one fluorine atom is fluoroethylene carbonate.
